(19) United States
(12) Patent Application Publication
(10) Pub. No.: US 2024/0346358 A1
(43) Pub. Date: Oct. 17, 2024

(54) RANDOMIZED READOUT ERROR MITIGATION FOR QUANTUM COMPUTING

(71) Applicant: Rigetti & Co, LLC, Berkeley, CA (US)

(72) Inventors: Marco Paini, Berkeley, CA (US); Andrew Thomas Arrasmith, Berkeley, CA (US); Andrew David Patterson, Berkeley, CA (US)

(73) Assignee: Rigetti UK Limited, London (GB)

(21) Appl. No.: 18/608,864

(22) Filed: Mar. 18, 2024

Related U.S. Application Data
(63) Continuation of application No. PCT/US2023/027045, filed on Jul. 6, 2023.
(60) Provisional application No. 63/358,834, filed on Jul. 6, 2022.
(60) Provisional application No. 63/426,252, filed on Nov. 17, 2022.

(51) Int. Cl. G06N 10/70; G06N 10/40

(52) U.S. Cl. CPC G06N 10/70; G06N 10/40

(57) ABSTRACT

Provided are a method and system for readout error mitigation, the method comprising: obtaining, with a quantum computing system, a phase value representing a tetrahedral group or supergroup; applying to a qubit, with the quantum computing system, a signal corresponding to the phase value representing an element sampled from the tetrahedral group or supergroup; measuring, with the quantum computing system, an output of the qubit after applying the signal; determining, with the quantum computing system, a full specification of an error channel for the qubit based on selected group operations and the measured outputs, the error channel being specifiable based on the tetrahedral group or supergroup; and calculating, with the quantum computing system, a correction based on the determined error channel specification, for a further readout measurement result of the qubit to produce an error mitigated readout result for the qubit.

### CROSS-REFERENCE TO RELATED APPLICATIONS

The present application is a continuation of International Patent Application PCT/US2023/027045, titled RANDOMIZED READOUT ERROR MITIGATION FOR QUANTUM COMPUTING, filed 6 Jul. 2023, which claims the benefit of the two following provisional patent applications: U.S. Provisional Patent Application 63/358,834, titled RANDOMISED READOUT ERROR MITIGATION, filed 6 Jul. 2022 and U.S. Provisional Patent Application 63/426,252, titled RANDOMISED READOUT ERROR MITIGATION, filed 17 Nov. 2022. The entire content of each afore-mentioned patent filing is hereby incorporated by reference.

### BACKGROUND

### 1. Field

The present disclosure relates generally to methods for error mitigation in quantum computing.

### 2. Description of the Related Art

Applications involving quantum computers require the ability to read out the results of measurements, e.g., readout collapsed states of quantum bits (qubits). The readout process itself may be subject to errors, both correlated (e.g., due to relationships between qubits) and uncorrelated errors. Current hardware, including in multiple qubit types (e.g., superconducting qubits, photonic qubits, etc.), may exhibit substantial (e.g., nonnegligible) correlated errors, which may provide an obstacle to large scale, practical quantum computing. Techniques to mitigate these errors may require gathering and manipulating data sets that grow exponentially with the number of quantum bits in order to calculate and compensate for correlated errors. Such data size restrictions may prohibit the application of these error mitigation techniques at scale, where speed and data storage requirements may prove unwieldy.

### BRIEF DESCRIPTION OF THE DRAWINGS

Aspects of the present techniques will be better understood when the present application is read in view of the following figures in which like numbers indicate similar or identical elements:

FIG. 1 is a schematic diagram that illustrates an example control system, in accordance with one or more embodiments.

FIG. 2 is a graph depicting distributions of readout error correlation coefficients, for one or more embodiments.

FIG. 3 is a graph depicting readout fidelities with and without readout error mitigation, according to one or more embodiments.

FIGS. 4A-4E are sections of a schematic diagram illustrating an example process flow, in accordance with one or more embodiments.

FIG. 5A is a flowchart illustrating an example of randomized compiling/randomized benchmarking, according to an example embodiment.

FIG. 5B is a flowchart illustrating an example of probabilistic error cancellation, according to an example embodiment.

FIG. 5C is a flowchart illustrating an example of stochastic optimization, according to an example embodiment.

FIG. 6 is a system diagram that illustrates an example quantum computing system, in accordance with one or more embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases just as importantly, recognize problems overlooked (or not yet foreseen) by others in the fields of quantum computing. Indeed, the inventors wish to emphasize the difficulty of recognizing those problems that are nascent and will become much more apparent in the future should trends in industry continue as the inventors expect. Further, because multiple problems are addressed, some of the present embodiments are problem-specific, and not all embodiments address every problem with traditional systems described herein or provide every benefit described herein. That said, improvements that solve various permutations of these problems are described below.

Some embodiments of the present techniques can be used as a part of extracting information from states prepared on a quantum computer, including when measurement of those states induces or otherwise includes measurement errors. As these measurement errors may distort the properties of the state, they may limit accuracy of quantum computation. Some embodiments may make use of random (e.g., at least quasi-random, stochastic, etc.), uncorrelated rotations performed on qubits immediately prior to the measurement step (e.g., a step in which the states of the qubits are collapsed and measured) in a quantum computation. In some embodiments, this process may be repeated many times. By recording the rotations chosen for each qubit (e.g., as applied before the measurement step) at each repetition, a measure and direction of the distortion of the measurement error may be determined. From this, desired properties of the quantum state may be reconstructed, such as by using post-processing with a classical processor. In some embodiments, this randomized readout technique may cause the breaking of correlations between various qubits—e.g., may reduce correlation error. This may cause a reduction in the readout errors between expectation values of operators on different qubits. By breaking correlation of errors (e.g., between correlated qubits of the quantum system) there may be exponentially fewer parameters to measure in order to perform the error mitigation than many prior approaches. In some embodiments, additional method may be used to mitigate readout and other errors, including random compiling, random benchmarking,

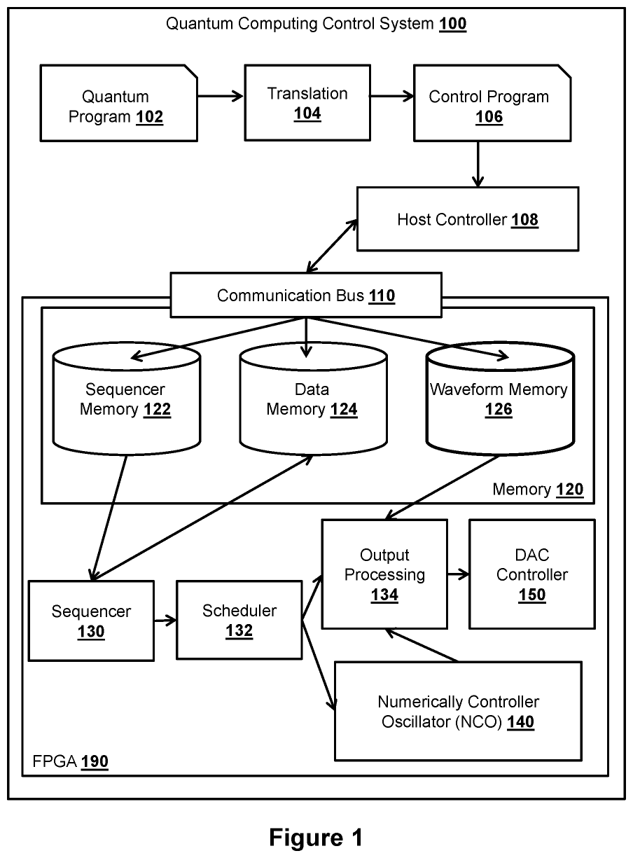

FIG. 1 is a schematic diagram that illustrates an example quantum computing control system 100 (hereinafter “control system 100”), which may be used to implement one or more embodiments.

In some embodiments, a translation service 104 may be available that allows quantum program 102 (which may include operations available on a quantum processor) to be translated via software into a control program 106 containing information both for configuring the control system of the quantum computer and sequences of instructions for the firmware of the control system to execute. The quantum program 102 may include operations which are not quantum operations or which are not performed on a quantum processor. The translation service 104 may translate the quantum program 102 into one or more appropriate languages, such as a Quil. The translation service 104 may translate the quantum program 102 into the control program 106, where the control program 106 is configured for a type of quantum processing system, such as specific type of qubits, for specific type of quantum computers, such as a proprietary device, or for a specific quantum computer. In some embodiments, the quantum program 102 may include or be transmitted as a control program 106, including in embodiments where the translation service operates on a different computer system, such as a third-party translation service. The quantum program 102 or the control program 106 may be stored in any appropriate location, such as on memory connected by a bus, input/output device (I/O device), etc. to a classical portion of the control system 100. The control program 106 may be a set of control programs, and may correspond to a set of quantum programs 102.

In some embodiments, a host controller 108 may receive the control program 106 for execution. In some embodiments, the host controller 108 may be connected to the internal network and may receive the control program 106 for execution. The host controller 108 may receive the program (full or some data derived therefrom) and memory data, ensure the program and memory data are uploaded to the relevant sub-components in the system and coordinates their execution as needed. The host controller 108 may collate results data from the sub-components and returns it.

In some embodiments, the control program 106 may contain data allowing initialization of one or more memory, including a sequencer memory 122, a data memory 124, and a waveform memory 126. The sequencer memory 122, the data memory 124, and the waveform memory 126 may be parts of a memory 120, which may be in communication with the host controller 108, such as through a communication bus 110. The memory 120 may be part of a field-programmable gate array (FPGA) 190, including stored in firmware on the FPGA 190. The control program 106 may contain additional configurations or initialization states, such as for other processes in the control system 100.

In some embodiments, the sequencer memory 122 may be accessed by a sequencer 130. The sequencer memory 122 may include a set of instructions, which may be implemented by the sequencer 130, to enact the control program 106. The sequencer 130 may provide or control a sequence of pulses (e.g., microwave pulses) supplied to one or more qubits. The sequencer 130 may output information about the sequence of pulses (as it provides them, subsequent to provision, etc.) to the data memory 124. The sequencer 130 may be a specialized soft core processor configured to provide sequences to one or more qubits. The sequencer 130 may be implemented in firmware, including on the FPGA 190. In some embodiments, the control program 106 may contain instructions for one or more sequencer 130. Multiple sequencers 130 may operate on a qubit, including multiple sequencers 130 per qubit. The sequencer 130 may operate on one or more qubits.

In some embodiments, the sequencer 130 sends instructions (e.g., a subset of the control program 106, instructions determined by the sequencer 130 based on the control program 106, etc.) to a scheduler 132. The sequencer 130 may send instructions to the scheduler 132 via a particular instruction (e.g., OUTPort or any other suitable instruction that pushes or pulls data from one component to another). The scheduler 132 may be implemented in firmware, including on the FPGA 190, as shown in FIG. 1. In some embodiments, the scheduler 132 may co-ordinate one or more firmware blocks (e.g., programing units), which may be located on the FPGA 190. The firmware blocks may control generation of analog signals (e.g., microwave signals) that may be output by the control system 100 to control (e.g., set up, measure, etc.) a quantum computing system. In some embodiments, the scheduler 132 may function as a buffer to ensure that one output operation is completed before another output operation begins.

In some embodiments, the firmware blocks may include an output processing block 134 and a numerically controlled oscillator (NCO) 140. In some embodiments, the output processing block 134 may receive (or retrieve) waveform envelop information from the waveform memory 126, including in an as-needed (e.g., just in time) manner The output processing block 134 may perform additional processing on the waveform envelope information, such as scaling. The output processing block 134 may modulate the waveform envelop information, such as based on output of the NCO 140. The output processing block 134 may pass the waveform envelope information, including as-modified by the output of the NCO 140, to a digital to analog (DAC) controller 150. The DAC controller 150 may digitize the received waveform envelope information and send digitized output to a digital to analog (DAC), which may generate a corresponding analog signal (e.g., microwave signal) to control the quantum computing system.

In some embodiments, the NCO 140 may produce signals corresponding to an oscillation at a particular frequency—for example, at a resonance frequency corresponding to a quantum computing component to which the signal is applied. The signals may correspond to sine and cosine values for the particular frequency. In some embodiments, the NCO 140 may control both the frequency and phase of the signals, such as based on input from the sequencer 130. The sequencer 130 may output a control signal to the NCO 140, such as to synchronize the output of the NCO 140 with other operations (e.g., such as of the output processing block 134) which affect the analog output. The scheduler 132 may control synchronization of the NCO 140 (including with the output processing block 134). The NCO 140 may output a signal which controls (e.g., modifies) the waveform envelope information, such as at the output processing block 134.

The control system 100 of FIG. 1 may be used to perform an arbitrary rotation, which may be part of a randomized readout error mitigation process.

In some embodiments, a rotation (e.g., a random rotation, a quasi-random rotation, etc.) may be performed, such as on a single qubit, by performing the following sequence of quantum operations. This sequence is provided as an example, and may instead or additionally include other quantum or classical operations:
R_{Z}(a)
R_{X}(π/2)
R_{Z}(b)
R_{X}(π/2)
R_{Z}(c)
   wherein R_{Z} may be a rotation about the Z axis by an angle, R_{X} may be a rotation about the X axis by an angle, and where parameters a, b, and c may be randomly generated parameters (such as over a fixed interval). Herein, “random” includes quasi-random (e.g., apparently random but created by a non-random algorithm, a low discrepancy sequence which may fill a distribution space more uniformly than a true random sequence, etc.), apparently random, stochastically sampled points from a distribution, etc.

In some embodiments, as the result of a measurement operation may be unaffected by an immediately preceding R_{Z} rotation, the above sequence of quantum operations may be functionally equivalent to:
R_{Z}(a)
R_{X}(π/2)
R_{Z}(b)
R_{X}(π/2)
   where the sequence of quantum operations may further be equivalent (e.g., may be converted to) to a sequence of two signals (e.g., microwave signals) applied to a qubit.

In some embodiments, a set of scheduler instructions used to enact an R_{Z}(θ) quantum instruction may shift the phase of an NCO by an amount related (e.g., linearly related) to the parameter θ. In some embodiments, the set of scheduler instruction used to enact an R_{X}(θ) quantum instruction may be applied to a previously calibrated waveform envelope sent to the DAC after modulation with the output of the NCO, which may be calibrated to the correct frequency. In some embodiments, the above sequence of quantum operations may be reduced to an application of a single waveform twice with two arbitrary phases (e.g., phases a and b).

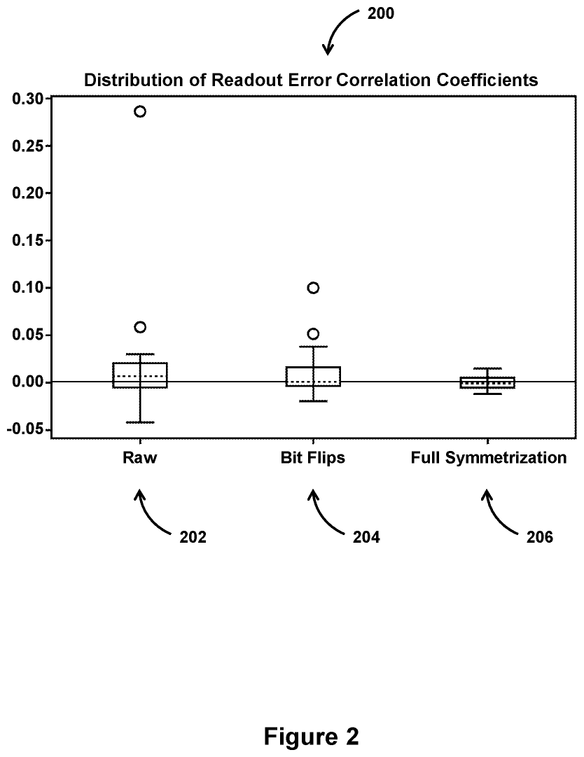

FIG. 2 is a graph 200 depicting distributions of readout error correlation coefficients, for one or more embodiments.

The graph 200 depicts distributions of readout error correlation coefficients between operators measured on pairs of qubits, where correlation errors may occur between two or more qubits. In the graph 200, “raw” (e.g., raw 202) corresponds the direct, unmitigated outputs, such as measured without any application of error mitigation (e.g., as measured expectation values, from concatenated results of multiple shots, etc.), “bit flips” (e.g., bit flip 204) corresponds application of a form of bit flip symmetrization (e.g., that has been previously employed in the field), and “full symmetrization” (e.g., full symmetrization 206) corresponds to the randomization procedure as described herein in one or more embodiment. As depicted in the graph 200, the full symmetrization results may be consistent with the correlations (e.g., between qubits, between physical effects on qubits, etc.) being substantially broken at the level of the precision of the measurement.

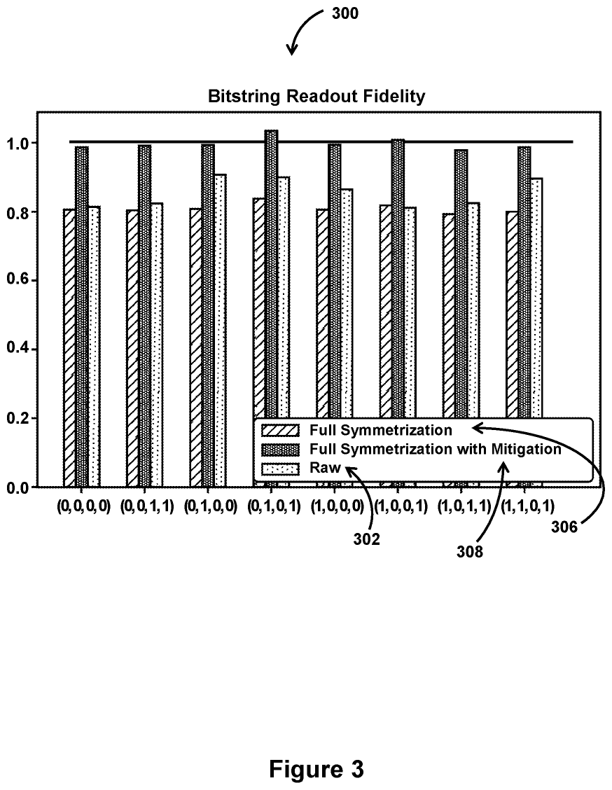

FIG. 3 is a graph 300 depicting readout fidelities with and without readout error mitigation, according to one or more embodiments.

The graph 300 depicts effects of mitigating readout fidelities of sampled bitstrings. In the graph 300, results for various 4-bit bitstrings are depicted. In the graph 300, as in FIG. 2, “raw” (e.g., raw 302) corresponds to the direct output of the measurement while “full symmetrization” (e.g., full symmetrization 306) denotes that the data was gathered using the randomization procedure as described in accordance with one or more embodiments described herein. In the graph 300, the “full symmetrization with mitigation” (e.g., full symmetrization with mitigation 308) data depicts the result of applying the error mitigation of an example embodiments described herein—which may include an element of statistical uncertainty, introducing a deviation, that can be equally larger or smaller, of the result from perfect readout—to the readout errors. In the graph 300, a result of 1.0 indicates perfect readout (e.g., ideal bitstring readout fidelity).

### Example Implementation of the Error Mitigation Technique

For ease of description, the following description is focused on a subset of quantum programs which may be described as a single quantum program that comprises three distinct sections in a specific time order, which is not to say that other quantum programs cannot be thought of or modified to follow this or another sequence which may be used in one or more embodiments:
1. Reset instructions on applied to at least a subset of qubits (e.g., qubits of a quantum computing system). Reset instructions may operate to clear a previous setting (e.g., randomize) applied to some of the qubits.
2. A sequence of gate instructions applied to at least a subset of qubits, which may be the same or different qubits that the qubits to which the reset instructions are applied. This may be a randomization step. This may be a computational step.
3. A measurement instruction on at least a subset of qubits. The measured qubits may include qubits which are not reset or gated or may not include some qubits which are reset and gated. That is to say, the measurement subset may be larger or smaller, or larger in some qubits and smaller in others, than the reset subset or gated subset.

The implementation of the error-mitigation technique and other embodiments described herein can be performed on programs not in this subset and using a control system not of this exact design, but to describe a particular implementation it is necessary context to consider a particular subset of programs and control system design, which is not to suggest that any other description herein is limiting.

In some embodiments, a program may be performed a large number of times, (e.g., N times). In some embodiments, a random gate instruction may be performed on each (e.g., substantially each, substantially all, all qubits involved in a subsequent measurement, etc.) single qubit before the measurement instructions are performed. The qubits may be gated (e.g., randomly) individually. The potential benefits of this to performance are described hereinafter and further in “Development and Demonstration of an Efficient Readout Error Mitigation Technique for use in NISQ Algorithms”, by Arrasmith, Andrew et al, 21 Apr. 2023, arXiv: 2303.17741v2 (https://arxiv.org/abs/2303.17741), herein incorporated by reference in its entirety (hereinafter, the “Arrasmith Reference”). Note that while, in some embodiments the particular rotation performed on each qubit may be random but may also be known after-the-fact such that this data can be used in the post-processing stages.

In some embodiments, an error channel may be determined for a qubit, such as, in some embodiments, a transition matrix T described in the Arrasmith Reference. A readout error channel may be used to determine a measure of readout error for a qubit. A channel (e.g., an error channel) may be fully specifiable for randomizing operations if the channel may be models substantially accurately as a tensor product of depolarizing channels. For a fully specifiable channel, a single number may be used to represent the channel for each qubit. A fully specifiable channel, such as a fully specifiable error channel, may allow more complete characterization of an error measurement, such as more complete than a symmetrization, “bit flip”, etc.

### Translation of Quantum Program

In some embodiments, a translation step may be used to generate a control program, such as from a quantum program (e.g., quantum programming sequence). Generation of the quantum program may entail the following during the translation step used to produce the control program:
1. The contents of the quantum program itself is repeated N times during translation (e.g., the quantum program is created to run a programming block N times);
2. All measure instructions have a sequence of gate operations inserted immediately preceding them, such as that outlined above, with their parameters selected from random intervals where appropriate (e.g., before each measure instruction, a gate operation is used to randomize the qubit to reduce correlated error); and
3. The sequence of random parameters used (e.g., applied in the gate operations) is stored by the host (e.g., in memory) for later retrieval and use in post-proces sing of the results.

In practice this method may be of limited use, which is not to suggest that it or anything else is disclaimed, as for any reasonably large N and any reasonable implementation of FPGA firmware there is unlikely to be enough available resource in the Sequencer Memory to store such a large set of instructions.

### Randomization Sampling With Array

In some embodiments, the method described above may be performed without step 1, such that the gate operations are applied and measurement taken, where the entire method may be performed N times—but where the N duplication of the program may not be explicitly stored. In such embodiments, the quantum operation may be hampered by performance costs (with a typical program taking 10-100 microseconds to execute, and an overhead time many orders of magnitude higher, which may be additive of the N iterations of the program, which is again not to suggest that this approach or anything else is disclaimed. Various optimizations are contemplated to improve the method to overcome these and other limitations for practical implementation. In some embodiments, pre-sampled rotations may be stored in data memory and then accessed by the sequencer program. For example:

During the translation step used to produce the control program:
1. An array may be inserted contiguously into data memory beginning at an offset A. The array may be initially configured to contain 2*N randomly generated phases. The randomly generated phases may be generated by any appropriate method.
2. A variable J may be inserted into data memory at a known offset J_ADDR (e.g., corresponding to an address J in the inserted array). The variable J may be initially configured to value A.
3. A random gate operation sequence as previously described may be inserted immediately preceding any measurement instructions. R_{Z} operations may be performed with instructions that, for each iteration:
   i. The value of J is read from data memory at address J_ADDR.
   ii. The value of the array at location J is read. The value of the phase ‘P’ may be set to the value read at address J.
   iii. The scheduler may be instructed to increment the phase of the NCO by P (e.g., the value of the phase read at address J).
iv. The value of J may be incremented, such as by 1, and stored at address J_ADDR for the next iteration.

In some embodiments, instructions may be added to the end of the program as needed to ensure a loop through the entire body of the program N times.

However, while the embodiment described above may improve use of (e.g., demands on) the Sequencer memory, such as by storing the array in the data memory, for reasonably large N the practical consideration of the size of available data memory must still be considered.

### Pseudo Random Number Generation During Compute

A sensible step may therefore be to, in some embodiments, generate random numbers as they are needed rather than pre-compute and store them. In some embodiments, the numbers used (e.g., the random numbers corresponding to gate operations) may be required to be known in the post-processing stages. In order to avoid storing the random number used (e.g., in data memory), in some embodiments a pseudo random number generator with a known initial state may be used, such that the random numbers may be generated (e.g., computer) when needed, such as when required for post-processing. As previously described, such reference to “random” numbers should be understood to include pseudo-random numbers as well. This leads to the following implementation method:

During the translation step used to produce the control program:
1. An initial state of the pseudo-random number generator may be encoded as a single integer or ‘seed’ and stored in data memory at SEED_ADDR.
2. A subroutine may be inserted into the control program, such as into the footer of the control program, that may consist of instruction to:
   i. Load the value from memory address SEED_ADDR into variable P.
   ii. Perform a sequence of arithmetic operations (e.g., incrementing, addition, multiplication, truncate, etc.) on P to generate the next value in the pseudo random sequence P′.
   iii. Store P′ at memory address SEED_ADDR.
   iv. Returning to the subroutine caller, leaving P′ available for use.
3. A random gate operation sequence as previously described may be inserted immediately preceding any measurement instructions. R_{Z} operations may performed with instructions to:
   i. Call the subroutine as described in step 2, leaving P′ available for use by the next instruction.
   ii. Send an instruction to the scheduler to increment the phase of the NCO by P′.

In some embodiments, instructions may be added to the end of the program as needed to ensure a loop through the entire body of the program N times.

In one particular implementation, the set of arithmetic operations performed in step 2 (u) may follow the standard set of operations for Linear Feedback Shift Register (LFSR) implementation using the linear XOR operation with taps selected such that the sequence follows a maximal cycle. This particular implementation choice may involve a minimal amount of simple computation to generate the next value in the sequence while also using very little state memory, making it suitable for the particular implementation of the Sequencer.

### Live-Computed With LUT Method

In some embodiments, the choice of the LFSR XOR algorithm may fix the distribution of the random sampling, which may be considered an approximately uniform distribution over the linear output space—even though LFSRs may fail to satisfy some statistical properties considered important under certain conditions in pseudo random number generation. In some embodiments, the above method may be extended to allow the use of an approximate arbitrary sampling distribution would be as follows:

During the translation step used to produce the Control Program:
1. An initial memory configuration may be generated where:
   i. The initial state of the pseudo-random number generator may be encoded as a single integer or ‘seed’ and stored in data memory at SEED_ADDR.
   ii. A look up table (LUT) may be inserted into data memory which samples fairly across the desired distribution. The LUT may have a size of 2**K samples and may begin at an address LUT_ADDR where LUT_ADDR mod 2**K=0.
2. A subroutine may be inserted into the footer of the control program that consists of instruction to:
   i. Load the value from memory address SEED_ADDR into variable P.
   ii. Perform a sequence of arithmetic operations on P to generate the next value in the pseudo random sequence P′.
   iii. Store P′ at memory address SEED_ADDR (e.g., for the next iteration).
   iv. The value at memory address (P′ AND (2**K−1)) OR LUT_ADDR may be read from memory as P″
   v. Returning to the subroutine caller, leaving P″ available for use.
3. A random gate operation sequence as previously described may be inserted immediately preceding any measurement instructions. R_{Z} operations may be performed with instructions to:
i. Call the subroutine as described in step 2, leaving P″ available for use by the next instruction.
ii. Send instruction to the scheduler to increment the phase of the NCO by P″.

In some embodiments, instructions may be added to the end of the program as needed to ensure a loop through the entire body of the program N times.

In some embodiments, more complex algorithms than the LFSR may be used for random number generation. In some embodiments, implementation of the LFSR may allow for an arbitrary distribution to be sampled from approximately, with a minimal increase to processing time required in the sequencer. In some embodiments, a more complex algorithm may also require more complex instructions to be available in the implementation of the sequencer and require a much larger amount of execution time in the sequencer, which is not to suggest that such more complex approaches or anything else is disclaimed. In some embodiments, a downside of this method may be a tradeoff between the size of the look-up table (LUT) in data memory and the accuracy over which the true distribution is sampled.

### Live Computed With a Highly Non-Uniform Distribution Over a LUT (“HNUD LUT”)

In some embodiments, using the LFSR XOR algorithm may result in an approximation to a uniform distribution for certain inputs, such as over non-negative integers below a maximum expressible integer—where the maximum expressible integer may vary with the number of bits used. For ease of description, the maximum expressible integer will be denoted as MAX_INT. As noted above, LSFRs may fail some statistical tests used to evaluate pseudo random number generators under certain circumstances.

To achieve a sampling from multinomial distributions over phases (e.g., phases applied by R_{Z}), some embodiments may utilize a pair (or more) of lookup tables. The first table may contain a set of phases (e.g., to be applied). The second table may be composed of entries such that the j^{th} entry may be given by MAX_INT*CDF(j), where CDF is the cumulative distribution function. This approach, in some embodiments, then modifies the above methods as follows:

During the Translation step used to produce the Control Program:
1. Initial memory configuration:
   i. The initial state of the pseudo-random number generator may be encoded as a single integer or ‘seed’ and stored in data memory at SEED_ADDR.
   ii. A lookup table may be inserted into data memory containing the distinct phases to be sampled over. The size of the lookup table may be the number of possible phases and the table begins at an address LUT_ADDR.
   iii. A lookup table may be inserted into data memory containing the CDF values associated with each distinct phase to be sampled over. Its size may be the number of possible phases and it may begin at an address CDF_ADDR.
2. A subroutine may be inserted into the footer of the control program that includes instruction to:
   i. Load the value from memory address SEED_ADDR into variable P.
   ii. Perform a sequence of arithmetic operations on P to generate the next value in the pseudo random sequence P′.
   iii. Store P′ at memory address SEED_ADDR.
   iv. Implement a binary search on the CDF value lookup table to locate the memory address CDR_ADDR+INDEX with the smallest integer INDEX such that the condition that the value stored at CDR_ADDR+INDEX is greater than P′/MAX_INT is satisfied. Increment an integer INDEX, starting from zero, until the condition that the value stored at CDR_ADDR+INDEX>P′/MAX_INT is satisfied.
   v. Read the value at memory address LUT_ADDR+INDEX from memory as P″
   vi. Returning to the subroutine caller, leaving P″ available for use.
3. A random gate operation sequence as previously described may be inserted in the desired locations. R_{Z} operations may be performed with instructions that:
   i. Call the subroutine as described in step 2, leaving P″ available for use by the next instruction.
   ii. Send instruction to the scheduler to increment the phase of the NCO by P″.
4. Instructions may be added to the end of the program as needed to ensure a loop through the entire body of the program N times.

In some embodiments, the HNUD LUT may use more computational cycles than the live-computed with LUT method discussed previously. However, for highly non-uniform distributions, this method may be expected to avoid at least some of the memory overhead associated with constructing the tables to provide sufficient resolution to sample the desired distribution.

Some embodiments may also augment such a method by summing the final result with a continuous value based on a function of the PRNG value to increase the total number of possible discrete phases, which may operate without requiring a large amount of memory. Some embodiments may also use other search methods in place of the binary search in step 2.4 depending on the optimum implementation.

### Parallel Compute Method

In some embodiments, for some implementation of the Sequencer the overhead of calling the LFSR subroutine, while minimal, may still be on the order of lOs of cycles of the sequencer—whereas a fixed phase shift may only require 1 cycle if the value was stored directly in the sequencer instruction or ˜4 cycles if the value was stored in data memory. As mentioned above, if a more complex pseudo random number generator (PRNG) subroutine is desirable to meet certain statistical requirements or to allow for a different sampling distribution, then the number of cycles of execution in the sequencer may increase dramatically. One possible alternative (or additional aspect of an) implementation of the above is therefore to use parallel compute methods:

In the firmware of the control system FPGAs:
1. A dedicated PRNG Firmware IP block may be inserted that is controlled by the sequencer. In a particular implementation, the sequencer may communicate with PRNG Firmware IP block via INPort and OUTPort instructions.
   i. Upon having a value written to a corresponding port, the initial seed value may be set to (e.g., become) this value.
   ii. Upon having a value read, it may send (e.g., automatically) the next value in the sequence.
2. There may be a small buffer, which may be clearable, that may be used to ensure the next value is always available to the sequencer within one cycle so long as some maximum average throughput is not exceeded.

During the translation step used to produce the control program:
1. The initial state of the pseudo-random number generator may be encoded as a single integer or ‘seed’ and stored in data memory at SEED ADDR.
   i. Instructions may be inserted into the header of the control program to read this value from data memory and write it to the PRNG firmware block.
2. A random gate operation sequence as previously described may be inserted immediately preceding any measurement instructions. R_{Z} operations may be performed with instructions to:
   i. Read the next value from the PRNG firmware block via an INPort instruction into a register P.
   ii. Send one or more instructions to the Scheduler to increment the phase of the NCO by P.

In some embodiments, instructions may be added to the end of the program as needed to ensure a loop through the entire body of the program N times.

In some embodiments, the above method may be extended similarly as from different ones of the methods described previously, such as to allow the sequencer to use a look-up table in data memory to arbitrarily alter the distribution from which numbers are selected. To achieve this same goal with less sequencer cycles required, in some embodiments, a further shared memory block may be added to the firmware and this look-up performed directly by the PRNG firmware block itself before values are forwarded to the sequencer. Finally, note that the PRNG firmware block is not limited to implementations of the LFSR XOR algorithm and so may be used directly to produce a different output distribution, although in practice algorithms implemented will still be limited by the FPGA resources available for its implementation and therefore the maximum throughput of generated PRNG numbers will be a function of the complexity of the algorithm used.

### Offline Post-Processing

In some embodiments, a method for completing post-processing is for the quantum computing system to wait for the measurement results and then, based on the measured results, estimate the desired operator expectation values following the standard Approximate State method. In some embodiments, this may entail executing, on the quantum computing system, the following steps to:
1. Decompose the operator(s) of interest into a sum over tensor product of single-qubit Pauli operators.
2. Compute the expectation value of each tensor product of single-qubit Pauli operators by:
   i. Multiplying each output bitstring by −2 and add 1 to each element to convert the results into strings of measurement eigenvalues.
   ii. Multiplying each of the elements of the measurement eigenvalue strings by a factor that accounts for the overlap between the measurement direction and the corresponding Pauli operator in the tensor product under consideration. For each string of values corresponding to a single measurement, multiplying the entries (that do not correspond to identity elements of the tensor product of Pauli operators) together. This may result in single-measurement estimators of the expectation value of the tensor product of Pauli operators.
   iii. Computing the mean of the single-measurement estimators to find an overall estimator of the expectation value of the tensor product of Pauli operators.
3. Sum the estimated expectation values of the tensor products of Pauli operators to construct the expectation values of the operator(s) of interest.

### Parallel/Live Post-Processing

In some embodiments, offline post processing may be performed on the FPGA if there were a need for immediate low latency feedback of the averaged results. There are circumstances (e.g., applications) where this live post-processing may be useful (such as part of a hybrid algorithm). However, for most current applications, the processing step may not be the bottleneck step (and is not likely not be in the future either (e.g., the classical processing in the hybrid step likely dwarfs post-processing time and therefore represents the most likely bottleneck step)). In some embodiments, live post-processing may be performed, while in other embodiments, offline post-processing may be performed.

In some embodiments, the random number generated may be used to index a look up table to allow for a random selection of a set of phases from a pre-prepared list of these sets of phases, such as previously described in reference to a live-computer with LUT method. In some embodiments, this may allow the phase to be selected from an arbitrary set of gates, such as the tetrahedral group. With each individual set of phases representing a gate when performed as part of a specific pulse sequence, this may effectively allow random selections of a gate from a list of gates.

The tetrahedral group of rotations may be particularly useful for sampling, which is not to say that other groups such as pole-concentration, direct, etc. cannot be useful or to disclaim any use thereof of other groups, as it forms a 2-design on the space of single qubits unitaries with only 12 elements. The tetrahedral group may be the minimal group that meets a case where the group is a tensor product of single qubit t≥2-designs. Further, the tetrahedral group (and its supergroup) may be irreducible on a subspace S, containing the tensor product on single-qubit unitaries on the subspace spanned by the set of basis vectors of a Pauli string.

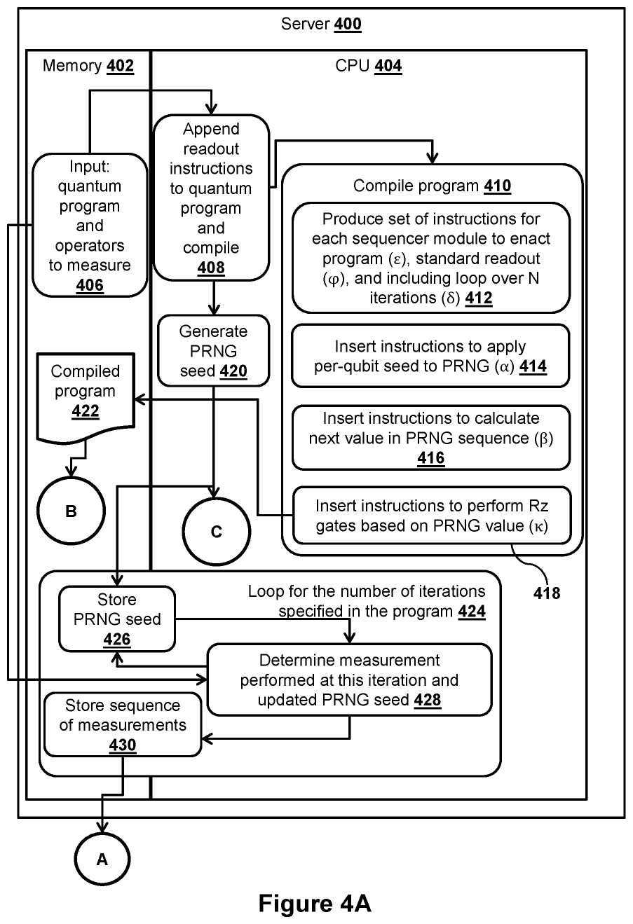

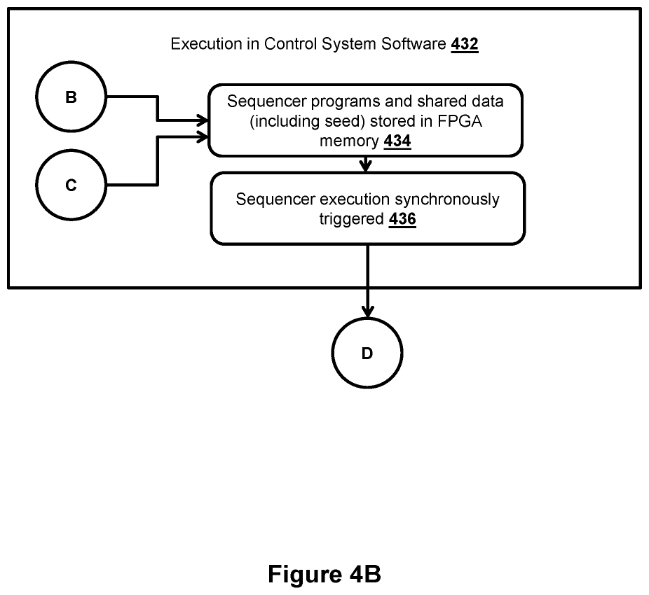

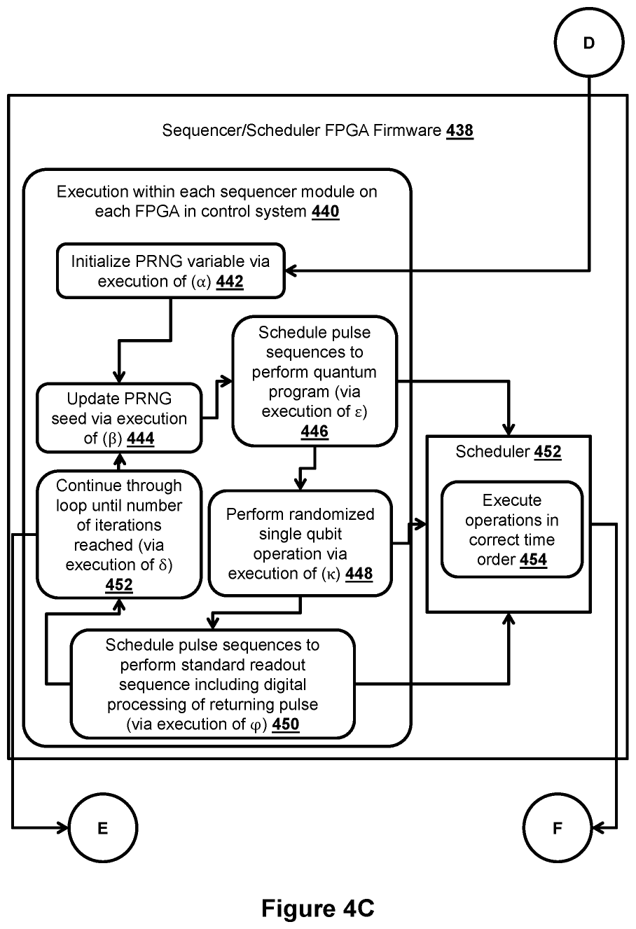

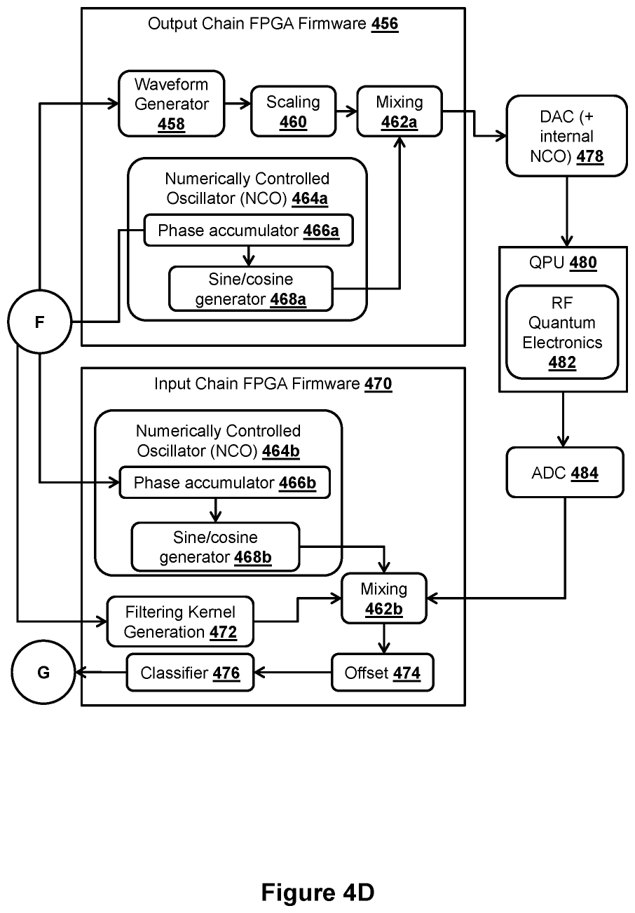

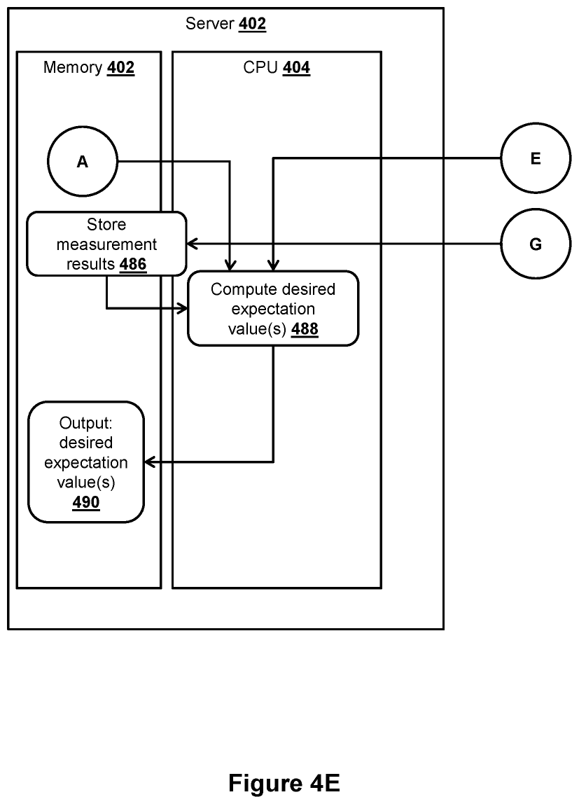

FIGS. 4A-4E are a schematic diagram illustrating an example process flow, in accordance with one or more embodiments.

### Process Flow and System Configuration

A detailed representation of an example embodiment is provided in FIGS. 4A-4E. Each figure in FIGS. 4A-4E depicts a segment of a larger flow (e.g., image), joined at points A-E which are labeled within the Figures. The flow may be performed by a server 400, which may include a memory 402 and a CPU 404, on a control system software 432, which may be the control system of FIG. 1, on sequencer/scheduler FPGA firmware 438, on a scheduler 452, on FPGA firmware, which may include output chain FPGA firmware 456 or input chain FPGA firmware 470, or on a quantum processing unit (QPU) 480. The server 400 may also be one or more of each of those elements, communicable through a network. The units depicted are provided for ease of description, and processes may be performed by different software or hardware units depicted as blocks. The process may begin with the input of a quantum program—which may be specified in the Quil language—and a description of the measurements to be taken, as depicted in FIG. 4A. The quantum program may be input or otherwise supplied to the memory 402 of the server 400, such as at a block 406. After that the process may proceed as follows:

The CPU 404 may append appropriate measurement instructions to the program, such as at a block 408, and compile it into an encrypted binary format, such as at a block 410. The appended measurement instructions may detail which qubits are to be measured as well as the manner of randomization (e.g., random phases, look-up table values, or other similar method).

During compilation, a set of instructions for each sequencer module may be produced. The set of instructions may contain a number of programming blocks (e.g., for subroutines), which may include instructions to enact a program ε, a standard readout φ, and a loop over N iterations δ, such as at block 412.

During compilation, additional instructions may also be inserted in each sequencer program based on the above instructions, to perform one or more of the following operations:

Apply a per-qubit seed to the PRNG seed (e.g., instructions α) to provide each qubit with a unique randomized measurement sequence, such as at block 414.

Calculate the next value of the PRNG value in the PRNG sequence (e.g., instructions β) such as before each measurement takes place, such as at block 416.

Perform two R_{Z} gates on each qubit (with an R_{X}(π/2) gate following each) whereby the angle of the R_{Z} rotation is dependent on the current PRNG value (e.g., instructions κ), such as at block 418. If a look-up table is used, then these rotations may be randomly chosen from a set (such as the tetrahedral group). The program (including a set of one or more sequencer programs) may be stored for later execution, such as in memory 402 at block 422.

Generate (or accept as an additional input) a global seed, such as at block 420, which may be for the linear feedback shift register (LFSR) pseudo-random number generator (PRNG) (or any other appropriate type of PRNG as described in one or more embodiment). This seed may have an integer value that serves as the state of the PRNG.

Store a copy of the PRNG seed in memory 402 on the server 400, such as at block 426.

As the program runs (or for determination of measurement outputs), the PRNG seed may be used to generate values for measurement determination. A loop 424 may operate for a number of iterations specified in the program, which may be the number of shots or other measurements taken, the number of randomization applied, etc. The loop 424 may contain the following operations: the PRNG seed may be stored at block 426, such as for an initial value generated at the block 420; for each iteration, a measurement determined at the iteration and the updated PRNG for the iteration may be determined, such as at block 428; and the sequence of measurements may be stored (e.g., at block 430), such as in the memory 402 on the server 400.

When the program is recalled for execution, the system (e.g., the control system software 432) may first write the sequencer programs to the sequencer program memory in each FPGA, such as at block 434 in FIG. 4B, as well as transfer data such as the look-up table and initial global seed to shared memory in each FPGA.

During execution, the PRNG instructions inserted by the compiler may be executed in parallel across the many sequencers/qubits, such as in a linear fashion alongside the rest of the standard program. For example, the sequencer execution may be synchronously triggered, such as at block 436.

The sequencer/scheduler FPGA may operate to execute the program 400, or loop, within each sequencer module on the FPGA in the control system (depicted in FIG. 4C), such as by performing one or more of the following operations:

Initialize the PRNG variable via execution of instruction α, such as at block 442— where instruction α were previously described in relation to the block 414.

Schedule pulse sequences to perform the program ε, such as at block 446—where the program ε was previously described in relation to the block 412.

Perform randomized single qubit operation via execution of instructions κ, such as at block 448—where instructions κ were previously described in relation to the block 418.

Schedule pulse sequences to perform standard readout sequence including digital processing of returning pulse(s) by execution of instructions φ, such as at block 450—where the instructions φ were previously described in relation to the block 412.

Continue through the loop (e.g., program 440) until a number of iterations is reached by execution of instructions δ, such as at block 444—where instructions for the loop δ were previously described in relation to the block 412.

The output of the loop (e.g., program 440), which may include output from the blocks 446, 448, and 450, may be passed to the scheduler 452. The scheduled may execute operations in a correct time order, such as at block 454.

In particular, the instructions for the R_{Z} gates may be such that, when executed (e.g., by the scheduler 452), based on the value of the PRNG value (either directly, or indirectly via a lookup table), the lower-level components in firmware may be directed to add an offset to the phase accumulator in a particular NCO in the output chain driving a particular qubit. For example, the scheduler 452 may control the output chain FPGA firmware 456 (e.g., of FIG. 4D) by controlling input delivered to a waveform generator 458 and a phase accumulator 466a or other component of an NCO 464a. The phase accumulator 466a may control a sine/cosine generator 468a, which may generate a signal (e.g., microwave signal, phase offset, etc.) which may be mixed with output of the waveform generator 458, such as at block 462a. The output of the waveform generator 458 may be scaled, such as at block 460, before or after mixing with output of the NCO.

The output of the output chain FPGA firmware 456 may be supplied to a DAC 478, which may include an internal NCO or other signal processing circuitry. The output of the DAC 478 may be supplied to the QPU 480, which may include RF quantum electronics 482. The output of the QPU 480, which may be a result of the input provided by the output chain FPGA firmware 456, may be provide to an ADC 484 and the digitized output may be supplied to the input chain FPGA firmware 470, such as for processing, interpretation, error-mitigation, etc.

The input chain FPGA firmware 470 may contain a NCO 464b, which may be the same NCO as the NCO 464a, substantially similar, operate on the same inputs, etc. The NCO 464b may contain a phase accumulator 466b, which may receive a control signal or other input from the scheduler 452. The phase accumulator 466b may supply a signal to a sine/cosine generator 468b, which may generate an output of the NCO 464b. The output of the NCO 464b and the ADC 484 may be mixed, such as at block 462b. The mixing may be controlled by a filtering kernel, which may be generated by a filtering kernel generation operation (such as at block 472) which may operate based on output from the scheduler 452. The output of the mixing may be used to determine an offset, such as at block 474, and be feed to a classifier, such as at block 476.

Measurement results (e.g., from the input chain FPGA firmware 470) may be sent back to the server 400 and stored in memory 402 of FIG. 4E) as in standard operation, such as at block 486.

A loop on the server may be executed sequentially or in parallel to iterate over the number of samples, thereby computing the measurements that correspond to the output of the PRNG at each iteration. These observables may then be stored for use in the post-processing. The stored values may reflect those generated in the FPGA firmware by the PRNG instructions.

Once both calculations are complete, the recorded sequence of measurements may then be combined with the measurement results in order to compute expectation values, such as at block 488, with the approximate state formalism. The desired expectation value(s) may be output or stored in memory 402, such as at block 490.

Some embodiments are expected to be advantageous when applied to high-speed superconductive circuits quantum computers. This is because these quantum computers are the faster quantum computing systems where a much larger number of shots can be executed in a given time.

Due to the symmetry and lack of correlation imposed on readout errors when using some embodiments, it will likely synergize with other error mitigation approaches. This technique would then also enable better mitigation of errors that occur during the execution of quantum circuits, not just during readout, in some embodiments.

In addition, beyond the application to quantum computing, some embodiments may potentially be used in the context of quantum sensing as such applications also have the potential to be highly sensitive to errors during readout.

### Utilizing Randomization in Other Applications

Beyond readout randomization, underlying techniques discussed herein may also accelerate other applications involving quantum processes with randomization in the control sequence. An inexhaustive list of examples (which is not to imply that other lists are exhaustive) of such applications includes randomized compiling, randomized benchmarking, probabilistic error cancellation, and optimization, and these are discussed in greater detail below.

### Randomized Compiling/Randomized Benchmarking

Randomized compiling is a quantum computing technique where random gates may be inserted in such a way as to leave the logical computation unchanged. Averaging over a set of such random insertions may symmetrize the hardware noise acting on the computation, which may result in simpler errors (e.g., errors which are simpler to computer and remove) in the output of the computation. Randomized benchmarking is a quantum gate characterization method that uses similar randomization to compute a single, symmetrized error rate which may indicate the quality of that gate. Randomized benchmarking may be a component of calibrating the control signals used in a quantum computation.

In the context of randomized compiling or randomized benchmarking, the above described techniques for generating pseudo-random phases for control sequences may allow for draws of random but logically equivalent control sequences on a per-shot basis. Implementing these techniques may include the following steps, in some embodiments:

1. Constructing on the server the desired quantum program. The quantum program may include phases that are left to be filled in on the quantum hardware.
2. Passing that quantum program to the translation step, and following live-computed LUT method with a modification to execute the circuit, passing in the desired group of phases to be sampled from the lookup table. The modification may synchronize the seeds between different qubit control systems to allow for coordinated random draws.

3. Passing the resulting measurement results to a post-processing method as appropriate for the end use case.

These steps, in some embodiments, may be expected to allow for rapid estimation of symmetrized results from computations and/or faster device calibrations.

It is to be appreciated that the above methods may reduce or otherwise lower the latency involved with communicating randomized sequences in some embodiments. This may be beneficial as latency may limit the degree of randomization that can be achieved in a system. That said, embodiments are not limited to implementations affording all of these benefits, as various engineering and cost tradeoffs are contemplated, which is not to suggest that any other description is limiting.

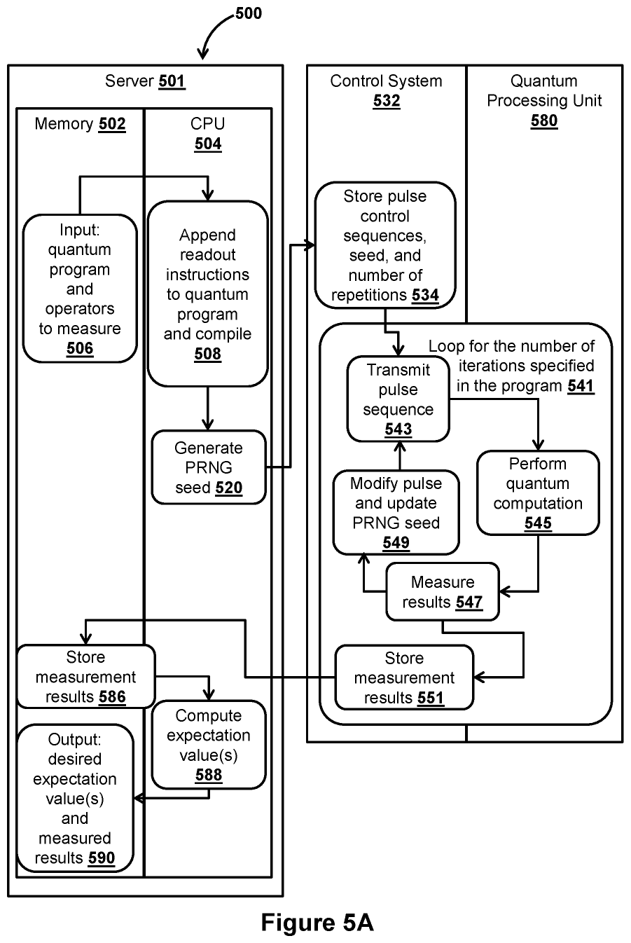

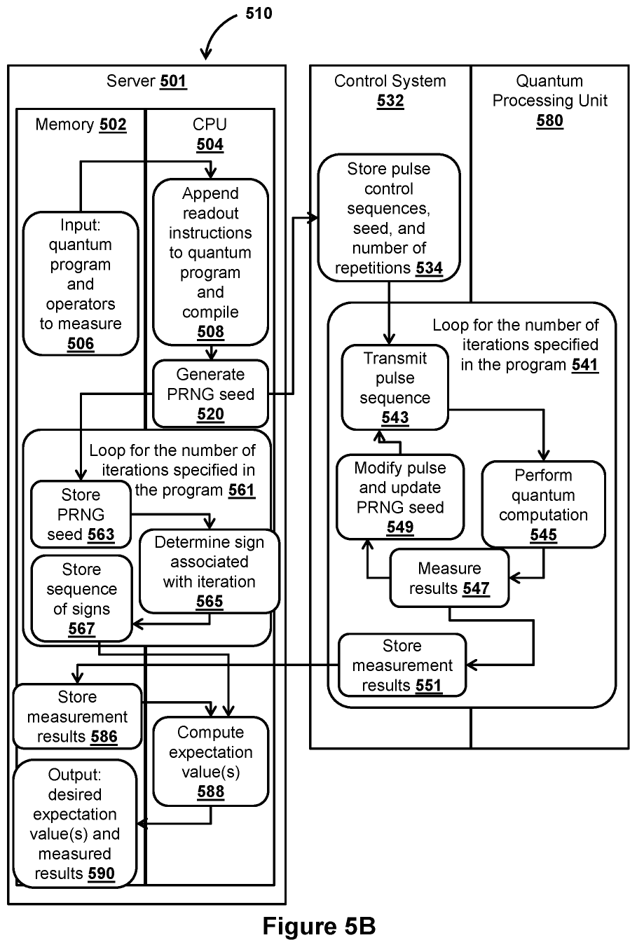

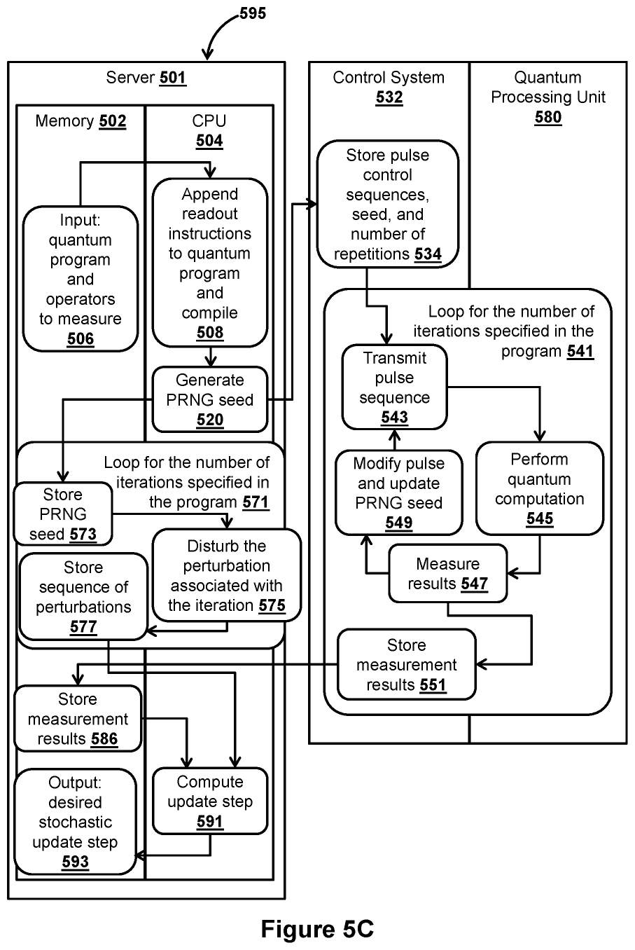

FIG. 5A is a flowchart 500 illustrating an example of randomized compiling/randomized benchmarking, according to an example embodiment. Flowchart 500 depicts example actions performed by a quantum computing system, including a server 501, which may contain a memory 502 and a central processing unit (CPU) 514, a control system 532 (which may be the control system 100 of FIG. 1), and a quantum processing unit (QPU) 530, which may contain one or more qubit.

At block 506, the memory 502 of the server 501 may receive, such as input, a quantum program, which may include quantum operators to measure. The memory 502 may transmit the quantum program to the CPU 514, where a set of readout instructions may be appended to the quantum program, such as at block 508. At block 520, a PRNG seed may be generated. The quantum program may be compiled. The quantum program may be transmitted to the control system 532, which itself may include one or more memory elements. At block 534, the control system may store pulse control sequences (e.g., for implementing the quantum program), seed (e.g., a seed value), and number of repetitions (e.g., N as previously described). The control system 532 may then control the QPU 580 to implement a loop 541, which may operate for the number of iterations specified in the program. The loop 541 may consist of a set of operations: a transmission of a pulse sequence to one or more qubit of the QPU 580 (such as at block 543); a performance of a quantum computation by the QPU 580 (such as at block 545); measurement of results of the quantum computation, such as by measurement by the control system 532 (such as at block 547); and modification of the pulse sequence and updating (e.g., tolling) of the seed (such as at block 549). The loop 541 may also include storage of measurement results, such as per iteration, per shot, cumulatively, etc. (such as at block 551). The measurement results may also be stored in the memory 502 of the server 501 (such as at block 586), such as due to communication of the measurement results from the control system 532 to the memory 502. At block 588, the CPU 504 may then determine expectation values based on the measurement results. At block 590, the memory 502 of the server may then output any desired expectation value(s) and measurement results.

### Probabilistic Error Cancellation

Probabilistic error cancellation is an error mitigation technique that may use random gate insertions drawn according to a probability distribution to approximately invert the effect of the errors on average. The probability distribution may be estimated from previously taken data characterizing the errors impacting the computation. The outcomes from the computations with random gate insertions may then be multiplied by a coefficient and a sign (where the sign may depend on the random draws) and be summed to find an estimate to the noiseless result.

In some embodiments, application of probabilistic error cancellation may look similar to the randomized compilation or benchmarking technique discussed previously but may include additional modifications.

Probabilistic error cancellation may include the following steps, in some embodiments:
1. Perform a sequence of calibration measurements, making use of the randomization method discussed above with reference to randomized compilation/benchmarking, or a similar method to do the benchmarking.
2. On the server, construct an approximate inverse of the stochastic errors found in the calibration. This inverse mapping may take the form of a probability distribution over random gate insertions.
3. Construct the desired quantum program with specified random phase insertion locations on the server and pass it to the translation step.
4. Use HNUD LUT method (as described previously) to sample random gate insertions from the probability distribution constructed in STEP 2
5. Pass the resulting measurement results to a post-processing step that may use the seeds passed to the FPGA LFSR routine to reconstruct the samples taken in order to compute a sign (e.g., a + or −) that may be passed to post-processing and that may depend on the end use case.

According to some embodiments, this method may allow for fast and efficient execution of the probabilistic error cancellation technique. That said, embodiments are not limited to implementations affording all of these benefits, as various engineering and cost tradeoffs are contemplated, which is not to suggest that any other description is limiting.

FIG. 5B is a flowchart 510 illustrating an example of probabilistic error cancellation, according to an example embodiment. Flowchart 510 depicts example actions and elements previously depicted in flowchart 500 of FIG. 5A, as well as additional elements. In a probabilistic error cancellation, the PRNG seed may be additionally stored in memory 502 on the server 501, such as at block 563. The server may then implement a loop 561, which may operate, including synchronously, with the loop 541 of the control system 532 and QPU 580. The loop 561 may operate for the number of iterations specified by the program, which may be the same number of iterations specified by the program for the loop 541. During the loop 561, the following operations may be performed: the PRNG seed may be stored in memory 502, such as at block 563; a sign (e.g., a + or −) associated with the iteration may be determined by the CPU 504, such as at block 565; and the sequence of such signs may be stored, such as in the memory 502 of the server 501, at block 567. The sequence of signs may be used, such as by the CPU 504, when determining expectation values (e.g., at the block 588), such as by using the signs and determine errors in a lower upper decomposition matrix.

### Stochastic Optimization

Many proposed techniques in quantum computing involve the modification of parameters in a program in order to solve an optimization problem. As such, frameworks may generally deal with a finite number of samples of measurements, where the optimization of the parameters may be an inherently stochastic process.

In the context of stochastic optimization, useful sub-computations such as computing a stochastic gradient estimate may be performed using one or more embodiments described herein, such as a FPGA acceleration. There may be many stochastic optimization routines, many of which involve a stochastic update step that involves random perturbations, which may be similar to a gradient estimate.

In order to implement such an update, some embodiments may perform the following steps:
1. Construct on the server the desired quantum program, which may specify the locations for the insertion of random phases. Pass the quantum program into the translation step.
2. Perturbations may be drawn uniformly or from a multinomial distribution, which may depend on the stochastic method chosen.
   i. For uniform perturbations: Use Live-Computed with LUT Method (as described previously) to uniformly sample phases corresponding to possible perturbations.
   ii. For multinomial perturbations: Use method HNUD LUT method (as described previously) to draw sample phases corresponding to the possible permutations, according to the specified probability distribution.
3. On the server, the random seeds may be passed to the FPGA, and the LFSR method may be used in order to determine which perturbations were used. Aggregate the measurement results received for each sampled perturbation and compute the corresponding stochastic update.

Applying this technique to the evaluation of stochastic gradients, the entire stochastic gradient may, in some embodiments, be estimated with a single job submission to the control system, which may eliminate the usual latency problems that may make such evaluations slow and costly. That said, embodiments are not limited to implementations affording all of these benefits, as various engineering and cost tradeoffs are contemplated, which is not to suggest that any other description is limiting.

Finally, it is to be appreciated that combinations of these applications, such as computing gradients while making use of randomized compilation and the above randomized readout error mitigation are possible and may be used. Additionally, these applications may also have the potential for accelerating and improving other error mitigation methods including but not limited to Clifford Data Regression and Zero Noise extrapolation as well as Error Correction methods that would require tailored noise.

FIG. 5C is a flowchart 595 illustrating an example of stochastic optimization, according to an example embodiment. Flowchart 595 depicts example actions and elements previously depicted in flowchart 500 of FIG. 5A and flowchart 510 of FIG. 5B, as well as additional elements. In a probabilistic error cancellation, the PRNG seed may be additionally stored in memory 502 on the server 501. The server may then implement a loop 571, which may operate, including synchronously, with the loop 541 of the control system 532 and QPU 580. The loop 571 may operate for the number of iterations specified by the program, which may be the same number of iterations specified by the program for the loop 541. During the loop 571, the following operations may be performed: the PRNG seed may be stored in memory 502, such as at block 573; a perturbation associated with the iteration may be disturbed, such as by application of stochastic noise, by the CPU 504 (for example, at block 575); and the sequence of such perturbations may be stored, such as in the memory 502 of the server 501, at block 577. At block 591, an update step may then be computed, such as by the CPU 504, based on the sequence of perturbations (such as stored in the memory 502) and the stored measurement results (such as stored in the memory 502 at block 586). At block 593, the memory 502 of the server may then output any desired stochastic update step.

Some embodiments may be expected to be particularly advantageous when applied to high-speed superconductive circuits quantum computers. This is because these quantum computers may be faster quantum computing systems where a much larger number of shots can be executed in a given time.

Due to the symmetry and lack of correlation imposed on readout errors when using some embodiments, some embodiments may be expected to synergize with other error mitigation approaches. Some embodiments of the present technique may then also enable better mitigation of errors that occur during the execution of quantum circuits, not just during readout.

In addition, beyond the application to quantum computing, some embodiments may potentially be used in the context of quantum sensing—as such applications also have the potential to be highly sensitive to errors during readout.

It should be emphasized that the present techniques are not limited to those affording all of the above-listed advantages, as various cost and engineering tradeoffs are envisioned that could yield different outcomes consistent with the presently described techniques, which is not to suggest that any other description herein is limiting.

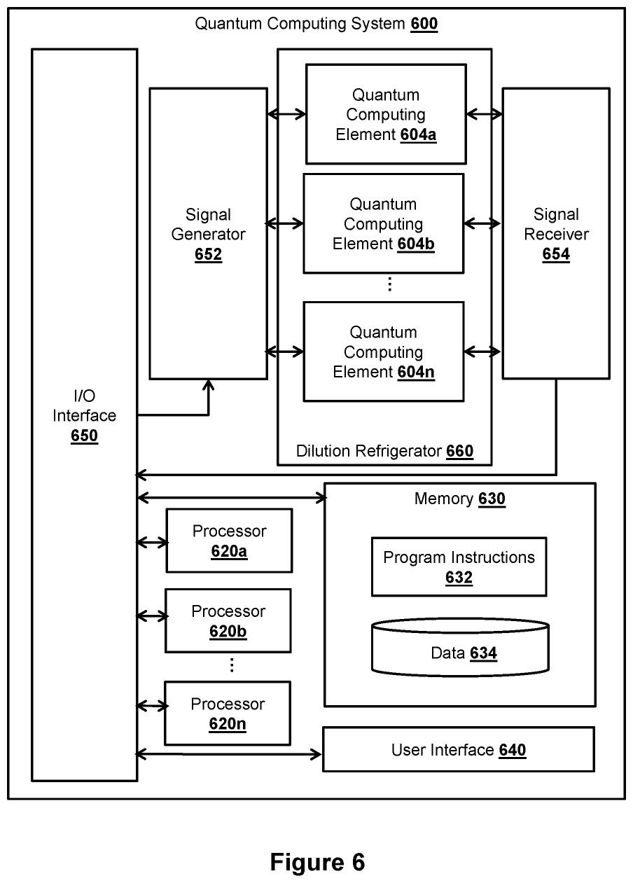

FIG. 6 is a system diagram that illustrates an example quantum computing system, in accordance with one or more embodiments. Various portions of systems and methods described herein may include or be executed on one or more computing systems similar to quantum computing system 600. Further, processes and modules described herein may be executed by one or more processing systems similar to that of quantum computing system 600.

Quantum computing system 600 may include one or more processors (e.g., processors 620a-620n) coupled to system memory 630, and a user interface 640 via an input/output (I/O) interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of quantum computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 630). Quantum computing system 600 may be a uni-processor system including one processor (e.g., processor 620a-620n), or a multi-processor system including any number of suitable processors (e.g., 620a-620n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Quantum computing system 600 may include a plurality of computing devices (e.g., distributed computing systems) to implement various processing functions.

Quantum computing system 600 may include one or more quantum elements (e.g., quantum elements 604a-604n), coupled to system memory 630, and a user interface 640 via an input/output (I/O) interface 650. The quantum computing elements 604a-604n may be qubits. The quantum computing elements 604a-604n may be quantum processors. The quantum computing elements 604a-604n may be any appropriate quantum computing elements, as previously described. The quantum computing elements 604a-604n may be within a dilution refrigerator 660, or another appropriate quantum isolation element.

The quantum computing elements 604a-604n may receive input (e.g., signals) from one or more signal generator 652. The signal generator 652 may include a sequencer, a scheduler, a NCO, or one or more element previously described in reference to FIG. 1. The signal generator 652 may supply microwave signals to the quantum computing elements 604a-604n. The signal generator 652 may supply any appropriate signal, such as an optical signal, a magnetic signal, etc. The signal generator 652 may include one or more transducers.

The quantum computing elements 604a-604n may send output (e.g., signals) to one or more signal receiver 654. The signal receiver may be any appropriate signal receiving device (e.g., measurement device). The signal receiver 654 may be inside the dilution refrigerator or in communication with the quantum computing elements inside the dilution refrigerator 660. The signal receiver 654 may measure any appropriate signal. The signal receiver 654 may include one or more transducer.

The user interface 640 may comprise one or more I/O device interface, for example to provide an interface for connection of one or more I/O devices to quantum computing system 600. The user interface 640 may include devices that receive input (e.g., from a user) or output information (e.g., to a user). The user interface 640 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. The user interface 640 may be connected to quantum computing system 600 through a wired or wireless connection. The user interface 640 may be connected to quantum computing system 600 from a remote location. The user interface 640 may be in communication with one or more other computing systems. Other computing units, such as located on remote computer system, for example, may be connected to quantum computing system 600 via a network.

System memory 630 may be configured to store program instructions 632 or data 634. Program instructions 632 may be executable by a processor (e.g., one or more of processors 620a-620n) or an quantum computing element (e.g., one or more of the quantum computing elements 604a-604n) to implement one or more embodiments of the present techniques. Program instructions 632 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 630 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 630 may include a non-transitory computer readable storage medium that may have program instructions stored thereon that are executable by a computer processor (e.g., one or more of processors 620a-620n) to cause the subject matter and the functional operations described herein. A memory (e.g., system memory 630) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 650 may be configured to coordinate I/O traffic between processors 620a-620n, signal generator 652, quantum computing elements 604a-604n, signal receiver 654, system memory 630, user interface 640, etc. I/O interface 650 may perform protocol, timing, or other data transformations to convert data signals from one component (e.g., system memory 630) into a format suitable for use by another component (e.g., processors 620a-620n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of quantum computing system 600 or quantum multiple quantum computing systems 600 configured to host different portions or instances of embodiments. Multiple quantum computing systems 600 may provide for parallel or sequential processing/execution of one or more portions of the techniques described herein.

Those skilled in the art will appreciate that quantum computing system 600 is merely illustrative and is not intended to limit the scope of the techniques described herein. Quantum computing system 600 may include any combination of devices or software that may perform or otherwise provide for the performance of the techniques described herein. For example, quantum computing system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Quantum computing system 600 may also be connected to other devices that are not illustrated or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from quantum computing system 600 may be transmitted to quantum computing system 600 via transmission media or signals such as electrical, electromagnetic, or digital signals, conveyed via a communication medium such as a network or a wireless link Various embodiments may further include receiving, sending, or storing instructions or data implemented in accordance with the foregoing description upon a computer-accessible medium. Accordingly, the present techniques may be practiced with other computer system configurations.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to cost constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X′ ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference. Grouped, numerated embodiments are listed below by way of example. Reference to prior characterizations of embodiments within are within each group.

### Embodiments

1. A method for readout error mitigation, the method comprising: obtaining, with a quantum computing system, a phase value representing a tetrahedral group or supergroup; applying to a qubit, with the quantum computing system, a signal corresponding to the phase value representing an element sampled from the tetrahedral group or supergroup; measuring, with the quantum computing system, an output of the qubit after applying the signal; determining, with the quantum computing system, a full specification of an error channel for the qubit based on selected group operations and the measured outputs, the error channel being specifiable based on the tetrahedral group or supergroup; and calculating, with the quantum computing system, a correction based on the determined error channel specification, for a further readout measurement result of the qubit to produce an error mitigated readout result for the qubit.
2. The method of embodiment 1, wherein obtaining the phase value comprises: obtaining an increment value for a given measurement; reading, from a register, a value corresponding to the increment value; and incrementing the increment value for a subsequent measurement.
3. The method of embodiment 1 or 2, wherein obtaining the phase value comprises sampling from a linear feedback shift register (LFSR).
4. The method of any one of embodiments 1 to 3, wherein obtaining the phase value comprises: obtaining a seed value for a given measurement; using the seed value as the phase value; and performing an arithmetic operation on the seed value to obtain a subsequent seed value.
5. The method of any one of embodiments 1 to 3, wherein obtaining the phase value comprises: obtaining a seed value for a given measurement; reading, from a look up table, a value corresponding to the seed value; and performing an arithmetic operation on the seed value to obtain a subsequent seed value.
6. The method of any one of embodiments 1 to 3, wherein obtaining the phase value comprises obtaining an input value from an external register.
7. The method of any one of embodiments 1 to 6, wherein applying to the qubit the signal corresponding to the phase value comprises applying a rotation to the qubit with the phase value.
8. The method of any one of embodiments 1 to 7, wherein applying to the qubit the signal corresponding to the phase value comprises applying a Rz rotation to the qubit with the phase value and a Rx(π/2) rotation on the qubit.
9. The method of embodiment 8, wherein applying a Rz rotation on the qubit with the phase value and a Rx(π/2) rotation on the qubit comprises applying a waveform with a second phase to the qubit.
10. The method of any one of embodiments 1 to 9, wherein obtaining a phase value comprises: obtaining a first value corresponding to a first phase; and obtaining a second value corresponding to a second phase; wherein applying to the qubit the signal corresponding to the phase value comprises: applying a first signal corresponding to the first value to the qubit; and applying a second signal corresponding to the second value of the qubit, wherein the first signal and the second signal are applied sequentially.
11. The method of embodiment 10, wherein applying the first signal and the second signal comprises steps for symmetrization.
12. The method of any one of embodiments 1 to 11, further comprising steps for correcting a measurement based on the calculated correction.
13. The method of any one of embodiments 1 to 12, further comprising performing quantum computing with the qubit.
14. The method of any one of embodiments 1 to 3, wherein obtaining a phase value comprises: obtaining a seed value for a given measurement; reading, from a first portion of a look up table, a first value corresponding to the seed value; reading, from a second portion of the look up table, a second value corresponding to the first value; using the second value as the phase value; and performing an arithmetic operation on the seed value to obtain a subsequent seed value.
15. The method of any one of embodiments 1 to 3, wherein obtaining a phase value comprises: obtaining a seed value for a given measurement; reading, from a first look up table, a first value corresponding to the seed value; searching, in a second look up table, for a second value wherein the second value is larger than a threshold, wherein the threshold is a function of the seed value; using the second value as the phase value; and performing an arithmetic operation on the seed value to obtain a subsequent seed value.
16. The method of any one of embodiments 1 to 15, further comprising: storing a parameter corresponding to the phase value in memory, wherein determining the error measurement comprises determining the error measurement for the qubit based on the parameter corresponding to the phase value and the measure output.
17. An quantum computing system comprising: a processor; a firmware register; one or more qubits; and a computer-readable medium storing instructions that when executed by the processor cause the processor to: obtain a phase value representing a tetrahedral group or supergroup; apply to a qubit of the one or more qubits a signal corresponding to the phase value representing an element sampled from the tetrahedral group or supergroup; measure an output of the qubit after applying the signal; determine a full specification of an error channel for the measured qubit based on selected group operations and the measured outputs, the error channel being specifiable based on the tetrahedral group or supergroup; and calculate a correction based on the determined error channel specification, for a further readout measurement result of the qubit to produce an error mitigated readout result for the qubit.
18. The system of embodiment 17, further comprising a memory, wherein the phase value is obtained from the memory.
19. The system of embodiment 17 or 18, further comprising a digital to analog converter, and wherein the signal applied to the qubit is an analog signal.
20. The system of any one of embodiments 17 to 19, further comprising a sequencer configured to apply the signal to the qubit.
21. The system of embodiment 20, wherein the sequencer further comprises a numerically controlled oscillator, and wherein applying the signal corresponding to the phase value to the qubit comprises adjusting the numerically controlled oscillator by a phase corresponding to the phase value.
22. The system of any one of embodiments 17 to 21, wherein operations to apply the signal corresponding to the phase value to the qubit comprises operations to apply a microwave signal to the qubit.
23. A method for randomization, comprising: obtaining a quantum computing sequence; inserting one or more parameterized quantum gates within the quantum computing sequence; obtaining a phase value for the one or more parameterized quantum gates; supplying a signal corresponding to the obtained phase value to the one or more parameterized quantum gates; and determining an output of the quantum computing sequence with the one or more parameterized quantum gates.
24. The method of embodiment 23, wherein the phase value represents a tetrahedral group of a supergroup of the tetrahedral group.
25. The method of embodiment 23 or 24, further comprising: determining a stochastic error of a quantum system; and determining an inverse of the stochastic error of the quantum system; wherein obtaining the phase value comprises obtaining a phase value from the inverse of the stochastic error of the quantum system.
26. The method of any one of embodiments 23 to 25, wherein the phase value is determined based on a look up table.
27. The method of any one of embodiments 23 to 26, further comprising steps for determining an error-mitigated output of the quantum computing sequence based on the determined output and the supplied signal.
28. The method of any one of embodiments 23 to 27, wherein obtaining a phase value for the one or more parameterized quantum gates further comprises steps for probabilistic error cancellation.
29. The method of any one of embodiments 23 to 28, further comprising performing a stochastic update based on the output of the quantum computing sequence with the one or more parameterized quantum gate.

What is claimed is:

1. A method for readout error mitigation, the method comprising:
obtaining, with a quantum computing system, a phase value representing a tetrahedral group or supergroup;
applying to a qubit, with the quantum computing system, a signal corresponding to the phase value representing an element sampled from the tetrahedral group or supergroup;
measuring, with the quantum computing system, an output of the qubit after applying the signal;
determining, with the quantum computing system, a full specification of an error channel for the qubit based on selected group operations and the measured outputs, the error channel being specifiable based on the tetrahedral group or supergroup; and
calculating, with the quantum computing system, a correction based on the determined error channel specification, for a further readout measurement result of the qubit to produce an error mitigated readout result for the qubit.

2. The method of claim 1, wherein obtaining the phase value comprises:
obtaining an increment value for a given measurement;
reading, from a register, a value corresponding to the increment value; and
incrementing the increment value for a subsequent measurement.

3. The method of claim 1, wherein obtaining the phase value comprises sampling from a linear feedback shift register (LFSR).

4. The method of claim 1, wherein obtaining the phase value comprises:
obtaining a seed value for a given measurement;
using the seed value as the phase value; and
performing an arithmetic operation on the seed value to obtain a subsequent seed value.

5. The method of claim 1, wherein obtaining the phase value comprises:
obtaining a seed value for a given measurement;
reading, from a look up table, a value corresponding to the seed value; and
performing an arithmetic operation on the seed value to obtain a subsequent seed value.

6. The method of claim 1, wherein obtaining the phase value comprises obtaining an input value from an external register.

7. The method of claim 1, wherein applying to the qubit the signal corresponding to the phase value comprises applying a rotation to the qubit with the phase value.

8. The method of claim 1, wherein applying to the qubit the signal corresponding to the phase value comprises applying a Rz rotation to the qubit with the phase value and a Rx(π/2) rotation on the qubit.

9. The method of claim 8, wherein applying a Rz rotation to the qubit with the phase value and a Rx(π/2) rotation on the qubit comprises applying a waveform with a second phase to the qubit.

10. The method of claim 1, wherein obtaining a phase value comprises:
obtaining a first value corresponding to a first phase; and
obtaining a second value corresponding to a second phase;
wherein applying to the qubit the signal corresponding to the phase value comprises:
applying a first signal corresponding to the first value to the qubit; and
applying a second signal corresponding to the second value of the qubit, wherein the first signal and the second signal are applied sequentially.

11. The method of claim 10, wherein applying the first signal and the second signal comprises steps for symmetrization.

12. The method of claim 1, further comprising steps for correcting a measurement based on the calculated correction.

13. The method of claim 1, further comprising performing quantum computing with the qubit.

14. The method of claim 1, wherein obtaining a phase value comprises:
obtaining a seed value for a given measurement;
reading, from a first portion of a look up table, a first value corresponding to the seed value;
reading, from a second portion of the look up table, a second value corresponding to the first value;
using the second value as the phase value; and
performing an arithmetic operation on the seed value to obtain a subsequent seed value.

15. The method of claim 1, wherein obtaining a phase value comprises:
obtaining a seed value for a given measurement;
reading, from a first look up table, a first value corresponding to the seed value;
searching, in a second look up table, for a second value wherein the second value is larger than a threshold, wherein the threshold is a function of the seed value;
using the second value as the phase value; and
performing an arithmetic operation on the seed value to obtain a subsequent seed value.

16. The method of claim 1, further comprising:
storing a parameter corresponding to the phase value in memory, wherein determining the error channel specification comprises determining the error channel specification for the qubit based on the parameter corresponding to the phase value and the measure output.

17. An quantum computing system comprising:
a processor;
a firmware register;
one or more qubits; and
a computer-readable medium storing instructions that when executed by the processor cause the processor to:
obtain a phase value representing a tetrahedral group or supergroup;
apply to a qubit of the one or more qubits a signal corresponding to the phase value representing an element sampled from the tetrahedral group or supergroup;
measure an output of the qubit after applying the signal;
determine a full specification of an error channel for the measured qubit based on selected group operations and the measured outputs, the error channel being specifiable based on the tetrahedral group or supergroup; and
calculate a correction based on the determined error channel specification, for a further readout measurement result of the qubit to produce an error mitigated readout result for the qubit.

18. The system of claim 17, further comprising a memory, wherein the phase value is obtained from the memory.

19. The system of claim 17, further comprising a digital to analog converter, and wherein the signal applied to the qubit is an analog signal.

20. The system of claim 17, further comprising a sequencer configured to apply the signal to the qubit.

21. The system of claim 20, wherein the sequencer further comprises a numerically controlled oscillator, and wherein applying the signal corresponding to the phase value to the qubit comprises adjusting the numerically controlled oscillator by a phase corresponding to the phase value.

22. The system of claim 17, wherein operations to apply the signal corresponding to the phase value to the qubit comprises operations to apply a microwave signal to the qubit.
